(19) United States
(12) Patent Application Publication
(10) Pub. No.: US 2002/0073329 A1
(43) Pub. Date: Jun. 13, 2002

(54) Tracking network devices

(76) Inventor: David S. Brombal, Plano, TX (US)

Correspondence Address: Dan C. Hu, TROP, PRUNER & HU, P.C., 8554 Katy Freeway, Ste. 100, Houston, TX, 77024, US

(21) Appl. No.: 09/734,246

(22) Filed: Dec. 11, 2000

(51) Int. Cl. G06F 11/30; G06F 17/60

(52) U.S. Cl. 713/200; 705/52

(57) ABSTRACT

A communications system includes a number of network devices that are coupled to a data network. Each of the network devices are associated with corresponding asset identifiers. A network server stores an asset tracking table that stores asset identifiers of network devices and associated information identifying users of the network devices. A node can send a request to the network server for user identifying information based on an asset identifier to enable the identification of the user that is currently assigned the network device.

### TECHNICAL FIELD

The invention relates to tracking network devices and associating them with respective users.

### BACKGROUND

Networks are widely used to interconnect various types of devices. Examples of networks include local area networks (LANs), wide area networks (WANs), and the Internet. Examples of network devices include desktop computers, portable computers, network telephones, and so forth.

A network, such as a network within a large organization, can be coupled to hundreds or even thousands of network devices. Over the life of a given network device, it is not uncommon for the network device to be assigned to a number of different users at different times. The evolution of network technology has made it easier to move equipment around within one or more networks. For example, the Dynamic Host Configuration Protocol (DHCP) enables a network device, upon booting, to request configuration information from a DHCP server. The configuration information includes a network address, such as an Internet Protocol (IP) address, assigned to the network device.

Thus, a network device can be unplugged from a first network outlet and moved to a second network outlet, which can often be associated with a different user and be located at a location that is relatively far away (such as on another floor or in another building) from the first outlet. If accurate records are not kept of the current user or location of a given piece of equipment, it may be difficult to find the equipment when something needs to be done with the equipment.

It is common practice in many organizations to lease computer equipment and other network devices. The terms of the leases are typically fixed (e.g., two or three years). At the end of the lease, the equipment is typically returned to the lessor, perhaps to be exchanged with new equipment. In another example, after a certain period of time, a scheduled upgrade of the equipment may be desirable. However, due to poor record-keeping, a network administrator may not be able to find a given piece of equipment easily. In many cases, valuable personnel hours may be wasted in trying to track network equipment.

A need thus exists for an improved and efficient method and apparatus of tracking network devices.

### SUMMARY

In general, according to one embodiment, a method to enable tracking of a network device comprises receiving information identifying user and receiving an asset identifier of the network device associated with the user. The user identifying information is then associated with the asset identifier.

Some embodiments of the invention may have one or more of the following advantages. An efficient method and apparatus is provided to allow tracking of network devices. By associating user identifying information with an asset identifier (corresponding to the network device), a current user of the network device can be determined. Once the current user is known, the network device can be easily found.

Other or alternative features and advantages will become apparent from the following description, from the drawings, and from the claims.

### BRIEF DESCRIPTION OF THE DRAWINGS

FIG. 1 is a block diagram of an embodiment of a communications system.

FIG. 2 is a message flow diagram of a process of associating user identifying information with an asset identifier of a network device, in accordance with an embodiment.

FIG. 3 is a message flow diagram for locating a network device when desired.

FIG. 4 illustrates an asset tracking table in accordance with an embodiment.

FIG. 5 is a block diagram of components of a network server in the communications system of FIG. 1.

### DETAILED DESCRIPTION

In the following description, numerous details are set forth to provide an understanding of the present invention. However, it will be understood by those skilled in the art that the present invention may be practiced without these details and that numerous variations or modifications from the described embodiments may be possible.

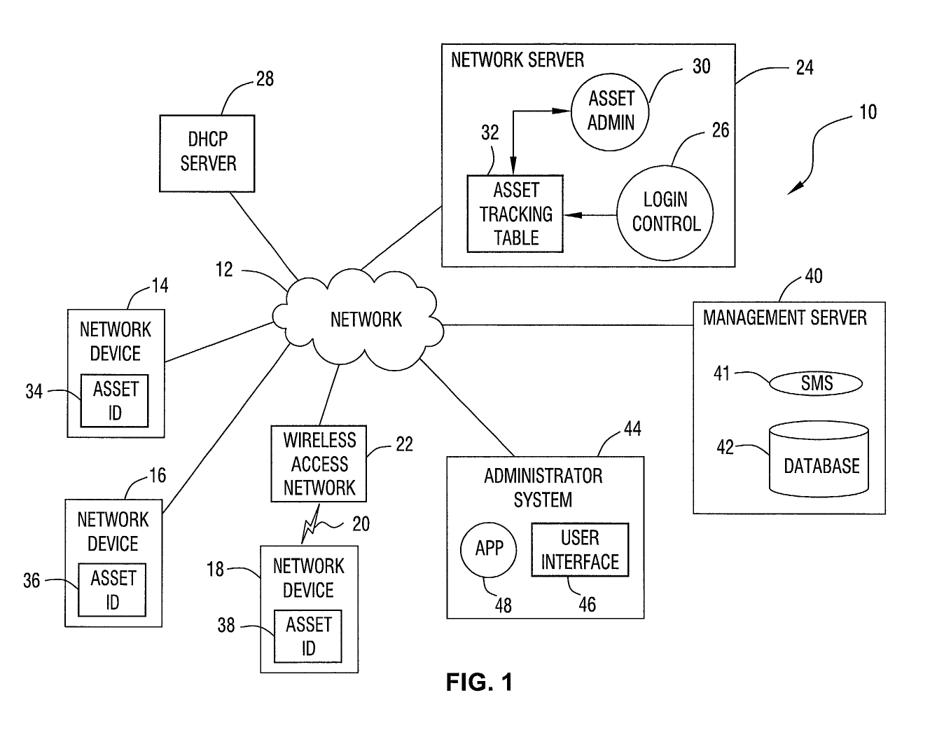

Referring to FIG. 1, a communications system 10 includes a data network 12 that is coupled to various network devices. The data network 12 can be a local area network (LAN) or a wide area network (WAN). The data network 12 referred to may include one or plural data networks. In some embodiments, the data network 12 is a packet-based network such as an Internet Protocol (IP) network. One version of IP is described in Request for Comments (RFC) 791, entitled “Internet Protocol,” dated September 1981; and another version of IP is described in RFC 2460, entitled “Internet Protocol, Version 6 (IPv6) Specification” dated December 1998.

Several network devices 14, 16, and 18 are coupled to the data network 12. The network devices 14 and 16 are connected by wires or cables to the data network 12, while the network device 18 is a wireless device that communicates using wireless signals 20 with a wireless base station 22 that is coupled to the network 12.

A network server 24 is also coupled to the data network 12. The network server 24 includes a login control module 26 that enables network devices 14, 16, and 18 to log onto the network to access information and other features. Once logged on, a network device has access to software loaded on one or more nodes coupled to the network 12 as well as databases and other sources of information in such nodes. The network devices are also able to perform various forms of communications over the data network 12, including electronic mail, web browsing, text chat, voice communications, and so forth.

In the example of FIG. 1, the data network 12 is also coupled to a Dynamic Host Configuration Protocol (DHCP) server 28. DHCP is described in RFC 1541, entitled “Dynamic Host Configuration Protocol,” dated October 1993. When a network device first starts or boots up on the network 12, it accesses the DHCP server 28 to obtain configuration information associated with the network device. The configuration information includes, among other things, a network address of the network device. In one example, the network address is an IP address. By using DHCP, it is relatively convenient to connect a network device to any one of plural outlets or ports that are available on the network 12. A network device can be unplugged from a first outlet and moved to a second outlet, with a DHCP procedure enabling configuration of the network device upon restart.

Because of the ease in which network devices can be moved around, it may be difficult for a network administrator to locate the network devices, particularly if the network devices are assigned to different users at different times. Over time, if accurate records are not maintained, the network administrator may lose track of the network devices.

In accordance with some embodiments of the invention, a tracking mechanism is implemented on the network 12 to track each network device by associating the network device with a user. An asset administration module 30 in the network server 24 is capable of associating user identifying information (such as login information received during a login procedure) with an asset identifier of the network device. The asset identifier and associated user identifying information are maintained in an asset tracking table 32, which can be stored in the network server 24 or on another node in the communications system 10.

As shown in FIG. 1, the network devices 14, 16, and 18 are associated with respective asset identifiers 34, 36, and 38. The asset identifiers 34, 36, and 38 may be one of several types of identifiers. For example, the asset identifier can be a central processing unit (CPU) identifier, such as the identifier associated with some microprocessors (e.g., PENTIUM® III microprocessors from Intel Corporation). Another type of asset identifier is an asset tag that is stored in fields associated with the basic input/output system (BIOS) of the network device. Yet another type of asset identifier is the serial number of the network device itself. More generally, the asset identifier can be any type of code (made up alphanumeric characters, for example) that uniquely identifies the network device.

As further shown in FIG. 1, a management server 40 is also coupled to the data network 12. The management server 40, which can run the Systems Management Server (SMS) tool 41 from Microsoft Corporation in one example, is capable of receiving or retrieving asset identifiers of the network devices 14, 16, and 18. The asset identifiers received from the network devices 14, 16, and 18 are stored in a database 42 contained in the management server 40. In one example, the database 42 is a relational database that is accessible by use of Structured Query Language (SQL) queries. In addition to asset identifiers, the database 42 can also store other types of information, such as detailed information regarding the hardware and software of network devices and the current network address (e.g., IP address). The database 42 contains multiple portions (e.g., tables, rows of tables, columns of tables, etc.), with each portion associated with a corresponding network device and storing the asset identifier along with other information of the network device. Thus, an asset identifier for a given network device can be extracted by issuing an SQL or other type of query over the data network 12.

During a login procedure, the asset administration module 30 in the network server 24 is capable of accessing the management server 40 to retrieve the asset identifier of the network device involved in the login procedure. Alternatively, the asset administration module 30 can retrieve the asset identifier directly from the network device during login. A network administrator, who is using an administrator system 44, may at some point issue a request to find a network device. A network administrator wishing to locate a network device can access the asset tracking table 32 to identify the most recent user of the network device. For example, this may be useful if the network administrator wishes to return a network device that is the subject of a lease that is about to expire. In another example, the network administrator may wish to perform maintenance or upgrade of the network device.

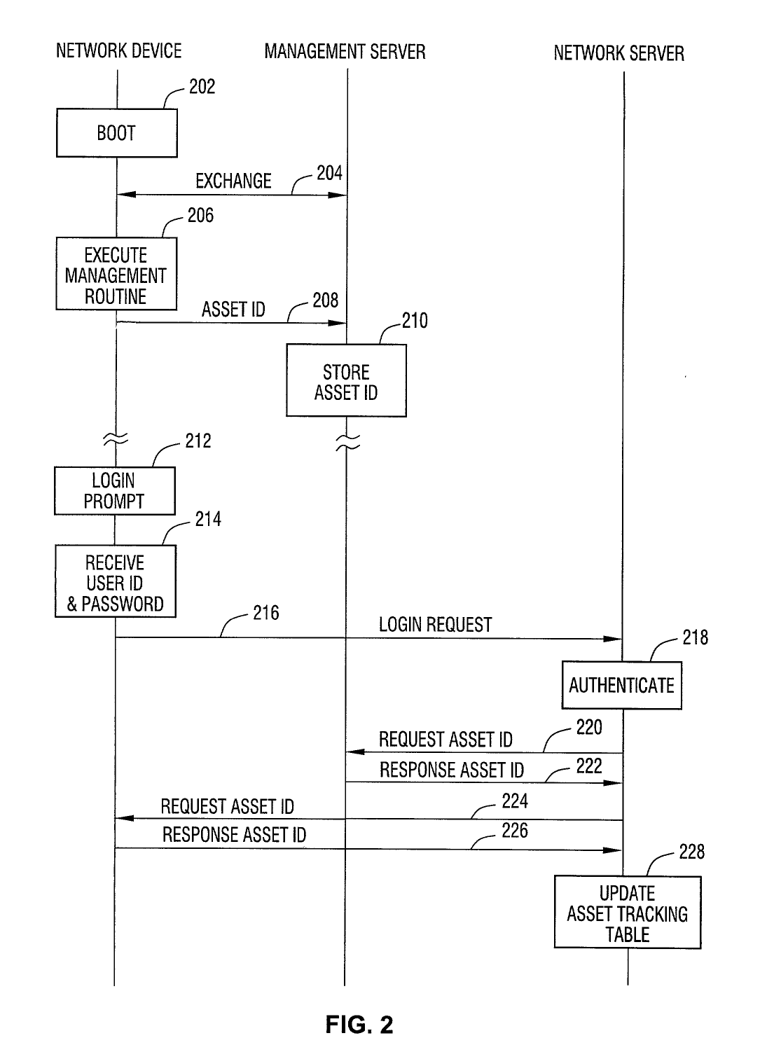

Referring to FIG. 2, a process of associating user identifying information with an asset identifier is illustrated. After a network device first boots (at 202), the network device performs an exchange (at 204) with the management server 40. The exchange may include the downloading of management routines from the management server 40. The management routines are executed (at 206) in the network device. Among the tasks performed by the management routines are the extraction of the asset identifier of the network device. The extracted asset identifier is then communicated by the network device (at 208) to the management server 40, which stores (at 210) the asset identifier in the database 42.

After booting, the network device presents a login prompt (at 212) in the display of the network device. If a user wishes to log on, the user typically enters a user ID and a password, which are received by the network device (at 214). A login request is then sent (at 216) from the network device to the network server 24. The login request includes the received user ID and password. The login control module 26 in the network server 24 then authenticates (at 218) the received user ID and password. As part of the login procedure, the IP address of the network device is also known.

The user ID is forwarded to the asset administration module 30 in the network server 24. In a first embodiment, the asset administration module 30 sends (at 220) the request (e.g., an SQL query) to the management server 40 to extract the asset identifier of the network device from the database 42. The request contains some type of tag (such as the IP address of the network device) that enables a lookup of information in the database 42 for the asset identifier of the network device. In response to the request, the management server 30 returns (at 222) the requested asset identifier. In an alternative embodiment, the asset administration module 30 can request the asset identifier (at 224) directly from the network device. In response to the request, the network device sends (at 226) the asset identifier back to the network server 24.

Upon receiving the asset identifier (from the management server 40 or from the network device), the asset administration module 30 updates (at 228) the asset tracking table 32. In one embodiment, the update may be performed whenever a user performs a login procedure. In another embodiment, the asset administration module 30 in the network server 24 checks to determine if an update is needed (such as when a change of users of a network device has occurred) and only performs an update of the table 32 when needed.

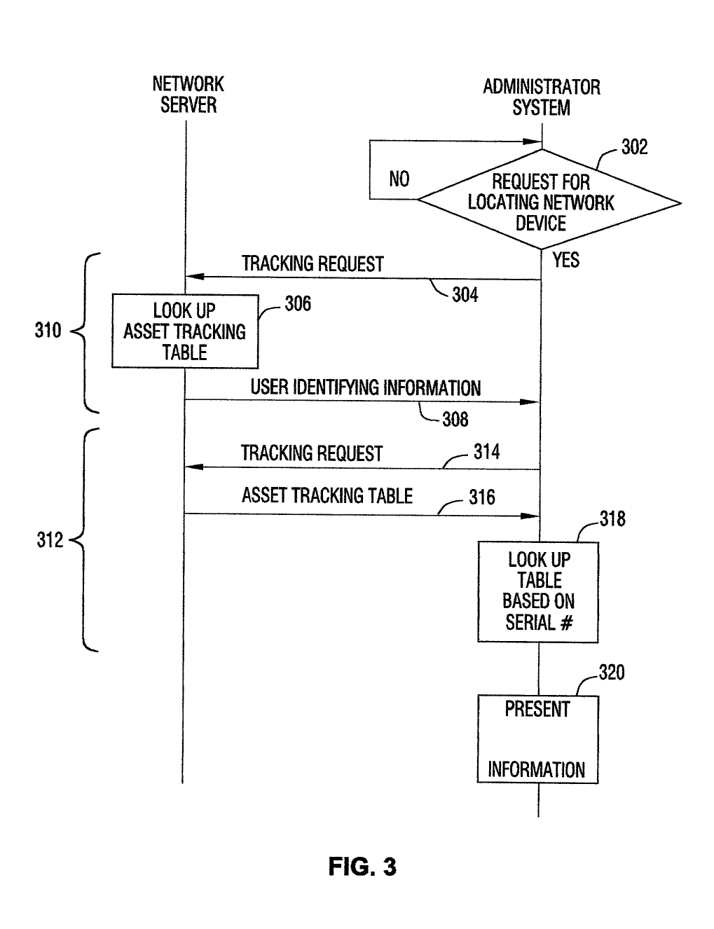

Referring to FIG. 3, a process of identifying a user of a network device is illustrated. The administrator system 44 determines (at 302) if a request is received for locating a network device. The request may be issued by a network administrator through a user interface 46 of the administrator system 44 (FIG. 1) for various reasons, which include returning the network device at the end of a lease, performing scheduled maintenance or upgrades, and other reasons.

When the locate request is received at 302, the administrator system 44 sends (at 304) a tracking request to the network server 24. The tracking request can contain the asset identifier of the network device to be located. In response to the tracking request, the asset administration module 30 in the network server 24 uses the asset identifier of the tracking request to look up an entry (at 306) in the asset tracking table 32. The user identifying information is extracted and transmitted (at 308) back to the administrator system 44. The acts 304, 306, and 308 make up a flow 310 according to a first embodiment. Alternatively, a flow 312 according to a second embodiment may be performed. In the flow 312, a tracking request is sent (at 314) from the administrator system 44 to the network server 24. In response to the request, the network server 24 sends the entire asset tracking table (at 316) to the administrator system 44. The administrator system 44 then looks up (at 318) an entry in the table that is based on the asset tag or serial number of the tracking request.

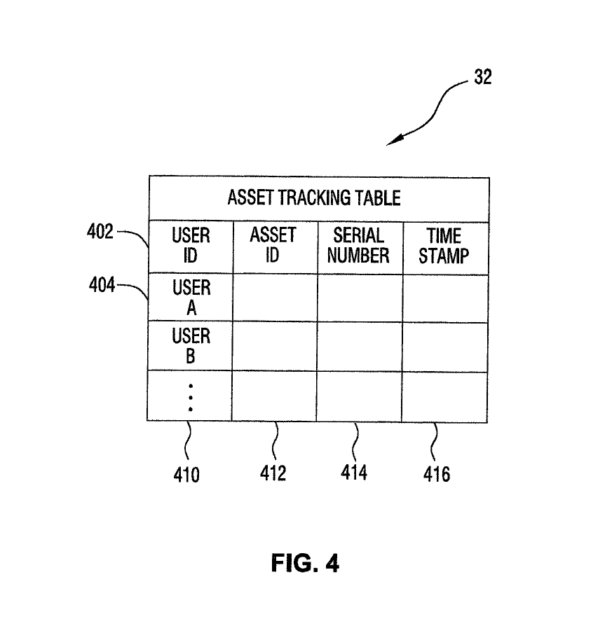

Referring to FIG. 4, one example of the asset tracking table 32 is illustrated. The asset tracking table 32 includes multiple rows 402, 404, and so forth associated with corresponding users. In addition, the table 32 includes a column 410 that contains the user identifying information, a column 412 that contains an asset identifier, a column 414 that contains the serial number of a network device, and a column 416 that contains a time stamp indicating the last time the user logged onto the network. The time stamp is updated in the table 32 during a login procedure. In some cases, the asset identifier and serial number in columns 412 and 414 may be the same so that the serial number 414 column or the asset identifier column 412 is not needed.

After the user identifying information has been determined according to either flow 310 or 312, the user identifying information is presented (at 320). The time stamp of the last login of the user can also be presented to enable the network administrator to confirm that the information in the tracking table 32 is reasonably recent. The information can be presented in the user interface 46 (FIG. 1) of the administrator system 44. Alternatively, the user identifying information can be communicated to an application 48 running in the administrator system 44 to perform automated tasks. For example, the application 48 may send an e-mail to the user to request that the user bring his or her network device to the network administrator.

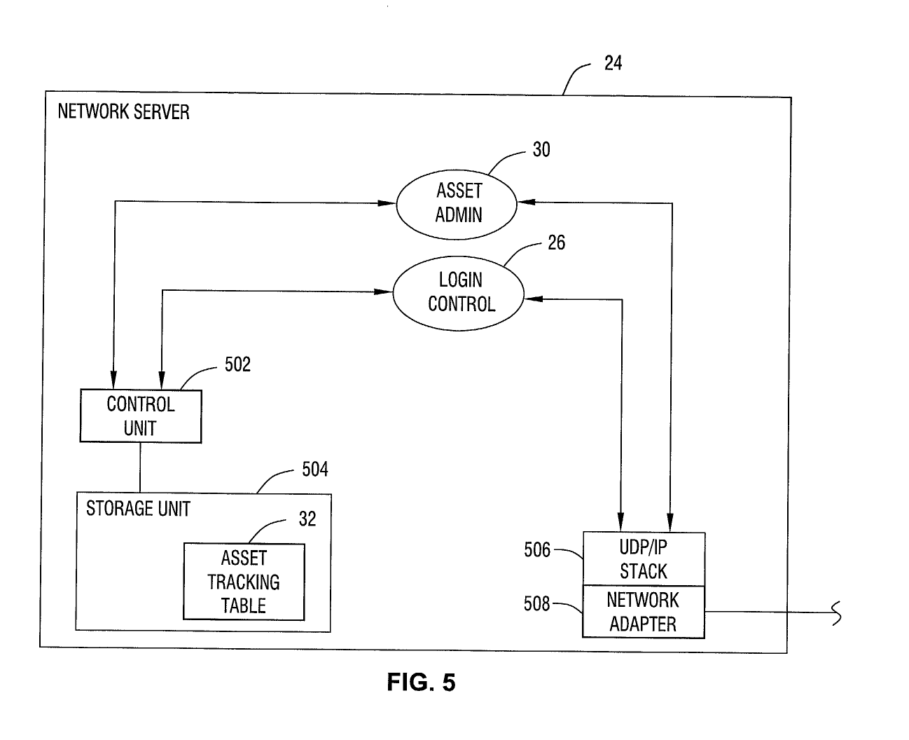

Referring to FIG. 5, components of the network server 24 according to one example arrangement are illustrated. The network server 24 includes a control unit 502 on which the asset administration module 30 and the login control module 26 are executable. A storage unit 504 coupled to the control unit 502 contains the asset tracking table 32. To communicate over the data network 12, the network server 24 includes a protocol stack that includes a network adapter 508 (e.g., an Ethernet adapter) and a UDP/IP (User Datagram Protocol/Internet Protocol) stack 506. Other layers (not shown) are also present in the network server 24. UDP is described in RFC 768, entitled “User Datagram Protocol,” dated August 1980.

The control unit 502 and other control units (not shown) in other network devices or servers each includes a microprocessor, a microcontroller, a processor card (including one or more microprocessors or microcontrollers), or other control or computing devices. As used here, a “controller” refers to software, hardware, or a combination of both, to perform pre-programmed tasks. A “controller” can also refer to a single component or to plural components (whether software or hardware).

The storage unit 504, and other storage units not shown, referred to in this discussion include one or more machine-readable storage media for storing data and instructions. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; and optical media such as compact disks (CDs) or digital video or versatile disks (DVDs). Instructions that make up the various software routines or modules in the various network devices or servers can be stored in respective storage units. The instructions when executed by a respective control unit cause the corresponding network element to perform programmed acts.

The instructions of the software routines or modules are loaded or transported to the network device or server in one of many different ways. For example, code segments including instructions stored on floppy disks, CD or DVD media, a hard disk, or transported through a network interface card, modem, or other interface device may be loaded into the device or server and executed as corresponding software routines or modules. In the loading or transport process, data signals that are embodied in carrier waves (transmitted over telephone lines, network lines, wireless links, cables, and the like) communicate the code segments, including instructions, to the network device or server. Such carrier waves are in the form of electrical, optical, acoustical, electromagnetic, or other types of signals.

While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. A method to enable tracking of a network device capable of communicating over a network, comprising:
receiving information identifying a user over the network;
receiving an asset identifier of the network device associated with the user; and
associating the user identifying information with the asset identifier.

2. The method of claim 1, wherein receiving the user identifying information comprises receiving user login information.

3. The method of claim 1, wherein receiving the asset identifier comprises receiving at least one of an asset tag, an identifier of a processor in the network device, and a serial number of the network device.

4. The method of claim 1, further comprising storing the associated user identifying information and asset identifier in a table.

5. The method of claim 4, further comprising receiving a request to track the network device and accessing the table to extract one of the asset identifier or the user identifying information.

6. The method of claim 5, wherein the table contains plural asset identifiers associated with plural network devices, and wherein accessing the table comprises accessing the table to extract one of the plural asset identifiers.

7. The method of claim 4, further comprising:
receiving information identifying a second user;
receiving an asset identifier of a second network device associated with the second user;
associating the second user identifying information and the second network device asset identifier; and
storing the second user identifying information and the second network device asset identifier in the table.

8. The method of claim 1, wherein receiving the asset identifier comprises receiving the asset identifier from a database in a management server.

9. The method of claim 1, wherein receiving the asset identifier comprises receiving the asset identifier from the network device.

10. A system for use on a network, comprising:
a storage unit containing a table storing asset identifiers of network devices and information identifying users of the network devices; and
a controller adapted to update the table when users log onto the network.

11. The system of claim 10, wherein the user identifying information comprises login information of each user.

12. The system of claim 11, wherein the controller is adapted to receive an asset identifier of a network device associated with each user during a lo gin procedure.

13. The system of claim 10, wherein the controller is adapted to store a time indication in the table to represent time of usage of a network device by each user.

14. The system of claim 13, wherein the time indication comprises a time stamp created during a login procedure by each user.

15. The system of claim 10, wherein the asset identifier comprises at least one of an asset tag, an identifier of a processor in the network device, and a serial number of the network device.

16. The system of claim 10, wherein the controller is adapted to further receive a request containing an asset identifier and to extract user identifying information associated with the asset identifier in response to the request.

17. An article comprising at least one storage medium containing instructions that when executed cause a system to:
receive information identifying a user over the network;
receive an asset identifier of the network device associated with the user; and
associate the user identifying information with the asset identifier.

18. The article of claim 17, wherein the instructions when executed cause the system to further associate the user identifying information with network access time and date information.

19. The article of claim 17, wherein the instructions when executed cause the system to further store the associated user identifying information and asset identifier in a table.

20. The article of claim 19, wherein the instructions when executed cause the system to further store plural user identifying information and asset identifiers in the table.

21. The article of claim 17, wherein the instructions when executed cause the system to receive the user identifying information during a login procedure.

22. A data signal embodied in a carrier wave and containing instructions that when executed cause a system to:
store, in a storage device, asset identifiers of network devices and associated information identifying users of the network devices;
receive, from a node, a request for identifying a user of a first network device; and
communicate the user identifying information associated with the first network device to the node.

23. The data signal of claim 22, wherein the instructions when executed cause the system to use an asset identifier contained in the request to access the storage device to extract the user identifying information.

24. The data signal of claim 22, wherein the instructions when executed cause the system to store the asset identifiers and user identifying information in a table in the storage device and to communicate the table to the node in response to the request.
